(19) United States
(12) Patent Application Publication
(10) Pub. No.: US 2005/0204004 A1
(43) Pub. Date: Sep. 15, 2005

(54) Method and apparatus for managing status in a messaging program

(75) Inventor: Michael S. McKay, Grand Blanc, MI (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/798,922

(22) Filed: Mar. 11, 2004

(51) Int. Cl. G06F 15/16

(52) U.S. Cl. 709/206

(57) ABSTRACT

A method, apparatus, and computer instructions for identifying a number of current conversations open for a user in the messaging application. The user status is set to busy if the number of current conversations for the user equals a threshold. The status may be changed back to the original state if the number of current conversations is less than the threshold.

### BACKGROUND OF THE INVENTION

1. Technical Field

The present invention relates generally to an improved data processing system and in particular, a method and apparatus for processing data. Still more particularly, the present invention provides a method, apparatus, and computer instructions for managing instant messaging status for a user.

2. Description of Related Art

Instant messaging is an online chat medium, allowing users to communicate with each other and collaborate in real-time over a network data processing system. Instant messaging is commonly used over the Internet. Instant messaging applications monitor and report the status of users that have established each other as online contacts. This information is typically presented to a user in a window. Instant messaging applications also are often used by users conducting business. By utilizing instant messaging, business users can view each other's availability and initiate a text conversation with colleagues or customers when a desired contact becomes available.

Typically, with instant messaging applications, communications between users are initiated by users selecting the name of the person with which they desire to communicate. Then, the users type messages in a dialog box in the window and press “send”. These messages appear instantly on the other selected recipient's computer.

Until now, instant messaging has been developed largely for home users, but used by home and business users alike. Instant messaging allows an organization to deploy and utilize this “need-to-have” technology in a business setting.

With instant messaging, a user may communicate with many other users simultaneously. For example, a user may communicate with one or more clients or customers while exchanging messages with a co-worker or manager. Typically, each of these conversations or threads is represented by a window. As the number of conversations or threads increases, it becomes more difficult for the user to manage the conversations. At some point, the user becomes overwhelmed by the number of conversations and is unable to efficiently communicate with the other users.

Therefore, it would be advantageous to have an improved method, apparatus, and computer instructions for managing conversations in an instant messaging application.

### SUMMARY OF THE INVENTION

The present invention provides a method, apparatus, and computer instructions for identifying a number of current conversations open for a user in the messaging application. The user status is set to busy if the number of current conversations for the user equals a threshold. The status may be changed back to the original state if the number of current conversations is less than the threshold.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a diagram illustrating components used in managing conversations in an instant messaging system in accordance with a preferred embodiment of the present invention;

FIG. 5 is a diagram illustrating components used in an instant messaging system in accordance with a preferred embodiment of the present invention;

FIG. 6 is a flowchart of a process for managing status in an instant messaging application in accordance with a preferred embodiment of the present invention; and

FIG. 7 is a flowchart of a process for processing a request for an interrupt check in accordance with a preferred embodiment of the present invention.

### DETAILED DESCRIPTION OF THE PREFERRED EMBODIMENT

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

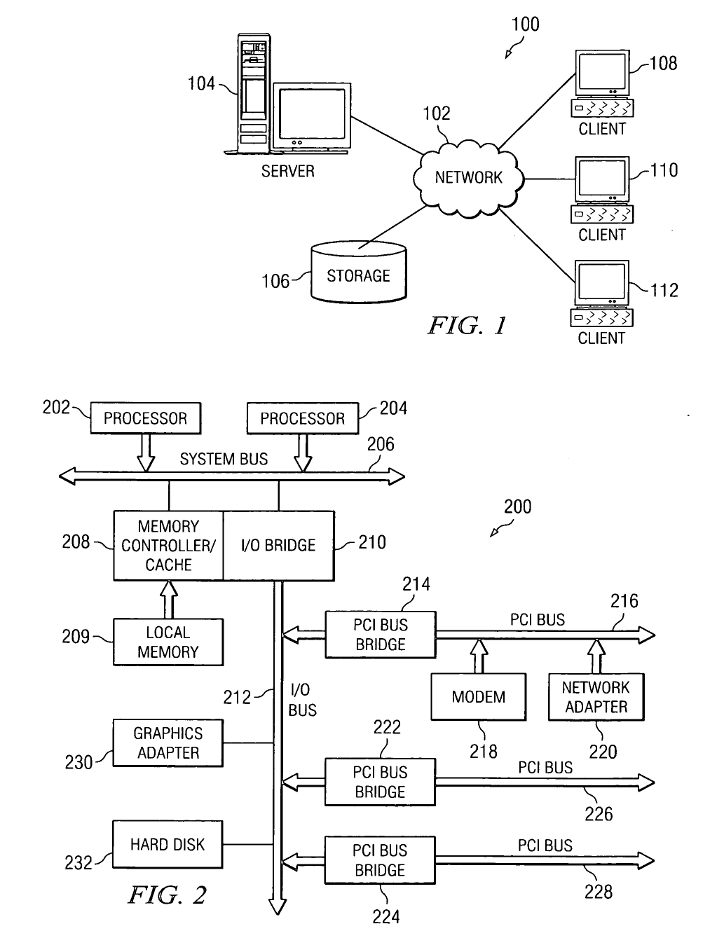

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

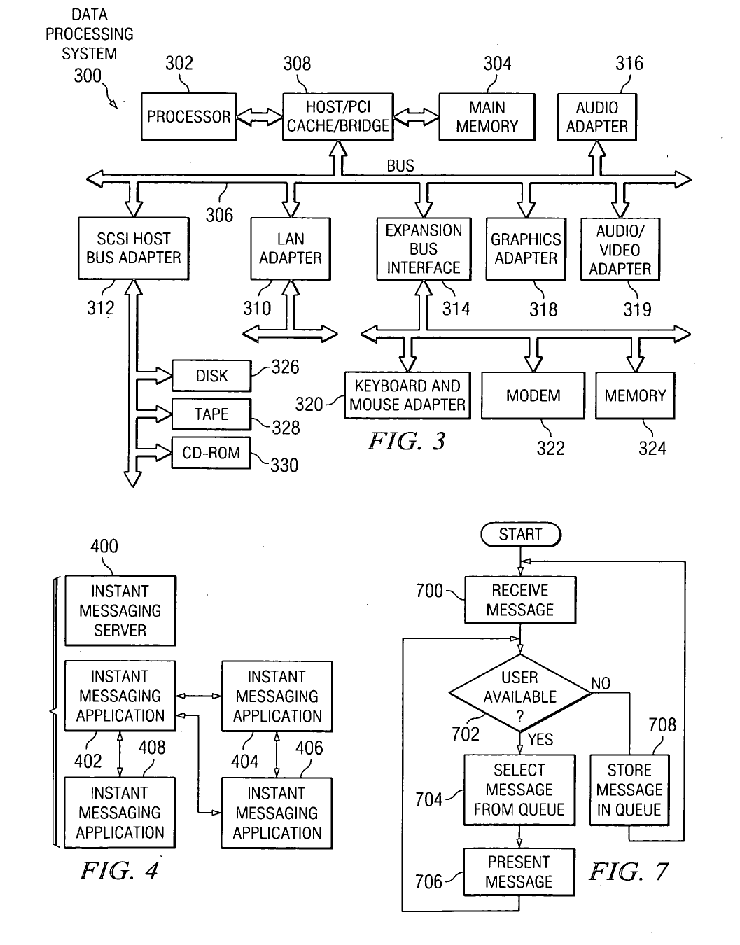

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are, connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides a method, apparatus, and computer instructions for managing conversations in an instant messaging program. A conversation is also referred to as a thread and is the messages exchanged between two users through instant messaging applications. These messages may include text and various files that may be transferred during the conversation. The mechanism of the present invention helps prevent a user from being overwhelmed by the presence of too many concurrent conversations. The online status of the user is changed to a status that does not allow for the initiation of new conversations by other users, such as a busy status, when the number of current conversations equals a threshold. In these illustrative examples, the threshold may be set through a user input. When the number of conversations is less than the threshold, the user status is returned to the previous state, such as available.

With reference now to FIG. 4, a diagram illustrating components used in managing conversations in an instant messaging system is depicted in accordance with a preferred embodiment of the present invention. In these illustrative examples, instant messaging server 400 may provide contacts and facilitate users finding other users for instant messaging sessions. Sessions may thereafter occur directly between the different instant messaging applications, such as instant messaging applications 402, 404, 406, and 408. In some cases, instant messaging server 400 may serve as a conduit for the different conversations.

In these examples, instant messaging application 402 has a conversation that is ongoing with instant messaging application 404. The user status for instant messaging application 402 is available. If the user sets the threshold to a value of two, then the user status for instant messaging application 402 changes from available to busy once the second conversation is initiated. In these examples, a conversation occurs when a message is sent from one instant messaging application to another instant messaging application and the message is accepted by the receiving instant messaging application. The status changes to unavailable once a conversation is initiated between instant messaging application 402 and instant messaging application 406.

In this example, instant messaging application 408 is unable to establish a conversation with instant messaging application 402 because the user status for instant messaging application 402 is busy. The conversation between instant messaging application 406 and instant messaging application 402 terminates when one of the users closes the window presenting messages for the conversation. The conversation may be terminated also by receiving a user input to end the conversation. At this point, the number of conversations is less than the threshold value of two. As a result, the user status is changed from busy to available. Then, instant messaging application 408 is able to establish a conversation with instant messaging application 402. In the illustrative examples, although other instant messaging applications are unable to establish or initiate a conversation with instant messaging application 402, this instant messaging application is able to initiate other conversations.

When a user is unavailable, others may optionally send messages to the user that are not presented to the user until the user becomes available. With this type of feature, the messages may be stored on instant messaging server 400. In most cases, the messages are received by the application and stored by the application in a queue when the user is unavailable. Instant messaging server 400 is more often used to store messages when a user is off-line.

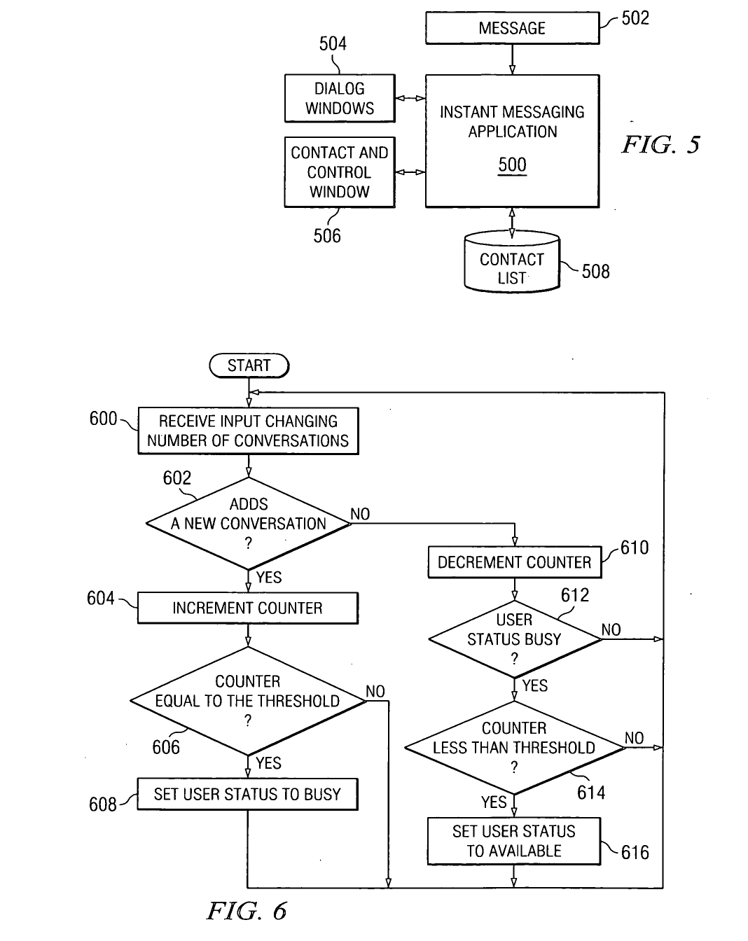

Turning next to FIG. 5, a diagram illustrating components used in an instant messaging system is depicted in accordance with a preferred embodiment of the present invention. These components may be implemented in an instant messaging application, such as instant messaging application 402 in FIG. 4.

In the depicted example, instant messaging application 500 processes messages, such as message 502 received from users located on remote data processing systems. As messages are received, these messages are presented in dialog windows 504. Messages exchanged between instant messaging application 500 and an instant messaging application on a remote data processing system form a conversation in these examples.

Additionally, dialog windows 504 provide an interface for user input to send messages to other users. Contact and control window 506 is presented by instant messaging application 500 to provide the user with a list of user names, as well as other information, such as, for example, identifying other users that are currently online. Contact and control window 506 also provides an interface to allow the user to set different preferences. For example, the user may set passwords required to access different names used in instant messaging sessions. Further, a user may employ contact and control window 506 to set other preferences, such as colors and fonts used in instant messaging application 500.

Further, the list of names presented by contact and control window 506 is stored in contact list 508 in these examples. Additional user names may be added or deleted from contact list 508. This contact list is employed in presenting the list of names within contact and control window 506. Additionally, the user may view the status of other users on contact and control window 506. This status may be, for example, available or busy. When the status is available, instant messaging application 500 will accept messages from another instant messaging application to start a new conversation. When the status of another user is busy, messages from instant messaging application 500 are not accepted by the other application for that user.

The mechanism of the present invention may be implemented within instant messaging application 500 to change the user status based on the number of current conversations that are open with instant messaging application 500. When the number of conversations equal or exceed a threshold value the user status is changed from available to busy, preventing the initiation of new conversations with instant messaging application 500 by other instant messaging applications. When the number of conversations that are open fall below the threshold value, the user status changes back to available from busy. In these illustrative examples, the number of conversations currently open is tracked using a counter that is incremented or decremented as conversations are opened or terminated.

With reference now to FIG. 6, a flowchart of a process for managing status in an instant messaging application is depicted in accordance with a preferred embodiment of the present invention. The process illustrated in FIG. 6 may be implemented in an instant messaging application such as instant messaging application 500 in FIG. 5.

The process begins by receiving input that changes the number of conversations (step 600). This input may be, for example, the user initiating a new conversation. Further, this input may be the receipt and presentation of a message from a remote user that initiates a new conversation. This input also may be a user input to the instant messaging application closing or terminating the conversation. Alternatively, the input may be an indication that the conversation has been terminated by the other user.

Next, a determination is made as to whether a new conversation is added (step 602). If a new conversation is added, then the counter is incremented (step 604). Then, a determination is made as to whether the counter is equal to the threshold (step 606). If the counter is equal to the threshold, the user status is set to busy (step 608). The process then returns to step 600 as described above. Also, in step 606 if the counter is not equal to the threshold, then the process returns to step 600 as described above.

In step 602, if a new conversation is not added then the counter is decremented (step 610). In this case, a conversation is closed or terminated. Next, a determination is made as to whether the user status is busy (step 612). If the user status is busy then a determination is made as to whether the counter is less than the threshold (step 614). If the value of the counter is less than the threshold, then user status is set to available (step 616), with the process then returning to step 600 as described above. Referring back to step 612 if the user status is not busy then the process proceeds to step 600 as described above. Referring back to step 614, if the counter is not less than the threshold, then the process proceeds to step 600 as described above.

With reference now to FIG. 7, a flowchart of a process for processing a request for an interrupt check is depicted in accordance with a preferred embodiment of the present invention. The process illustrated in FIG. 7 may be implemented in an instant messaging application such as instant messaging application 500 in FIG. 5.

The process begins by receiving a message (step 700). Next, a determination is made as to whether a user is available (step 702). The status of the user is determined in the manner described with respect to FIG. 6 above. If a user is available then messages are selected from a queue (step 704). In these illustrative examples, more than one message may be present in the queue. In this case, the message selected is based on a first-in-first-out (FIFO) system. At some point in time, the user status may change to busy from available. Then, the messages not yet selected remain in the queue.

Next, the message is presented (step 706). The process then proceeds to step 702 as described above. In these illustrative examples, the presentation of the message includes initiating the conversation with the sender of the message. If the sender is unavailable, the message is presented along with an indication that the sender is unavailable. A similar message may be presented if the sender is no longer on-line.

Referring back to step 702, if a user is not available then a message is stored in a queue (step 708). The process then proceeds to step 700 as described above.

In this manner, the mechanism of the present invention provides a call back mechanism that allows a user to automatically initiate messages when the user status becomes available. Further, a window or other control may be presented to display messages waiting in the queue. Such a display allows a user to select a message for display and may allow the user to initiate a conversation with another user whose message is stored in the queue.

Thus, the present invention provides a method, apparatus, and computer instructions for managing the initiation of conversations. The mechanism of the present invention changes the status of an instant messaging application to one that does not allow new conversations to be accepted or initiated by other users when the current number of conversations equals a threshold. The status is returned to one that allows for the initiation of new conversations when the current number of open conversations is less than the threshold.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method in a data processing system for changing a user status in a messaging program, the method comprising:
identifying a number of current conversations open for a user in the messaging program; and
setting the user status to busy if the number of current conversations for the user equals a threshold.

2. The method of claim 1 further comprising:
setting the user status to available if the user status is currently set to busy and if the number of current conversations is less than the threshold.

3. The method of claim 1, wherein the threshold is set by a user input.

4. The method of claim 1, wherein the messaging program is an instant messaging program.

5. The method of claim 1, wherein the identifying step is initiated when a user input creating a new conversation is received.

6. The method of claim 1, wherein the identifying step is initiated when a user input terminating a conversation is received.

7. The method of claim 1 further comprising:
responsive to receiving a message while the user status is busy, saving the message without presenting the message; and
responsive to the user status changing to available, presenting a saved message.

8. The method of claim 7, wherein the saved message is selected from a set of saved messages based on a first-in-first-out basis.

9. The method of claim 8 further comprising:
initiating a new current conversation with a user that originated the saved message.

10. The method of claim 9 further comprising:
continuing to present additional saved messages and initiating new conversations as long as the user status is available.

11. A data processing system for changing a user status in a messaging program, the data processing system comprising:
identifying means for identifying a number of current conversations open for a user in the messaging program; and
setting means for setting the user status to busy if the number of current conversations for the user equals a threshold.

12. The data processing system of claim 11, wherein the setting means is a first setting means and further comprising:
second setting means for setting the user status to available if the user status is currently set to busy and if the number of current conversations is less than the threshold.

13. The data processing system of claim 11, wherein the threshold is set by a user input.

14. The data processing system of claim 11, wherein the messaging program is an instant messaging program.

15. The data processing system of claim 11, wherein the identifying means is initiated when a user input creating a new conversation is received.

16. The data processing system of claim 11, wherein the identifying means is initiated when a user input terminating a conversation is received.

17. A computer program product in a computer readable medium for changing a user status in a messaging program, the computer program product comprising:
first instructions for identifying a number of current conversations open for a user in the messaging program; and
second instructions for setting the user status to busy if the number of current conversations for the user equals a threshold.

18. The computer program product of claim 17, wherein the second instructions includes:
sub-instructions for setting the user status to available if the user status is currently set to busy and if the number of current conversations is less than the threshold.

19. The computer program product of claim 17, wherein the threshold is set by a user input.

20. The computer program product of claim 17, wherein the messaging program is an instant messaging program.

21. The computer program product of claim 17, wherein the first instructions is initiated when a user input creating a new conversation is received.

22. The computer program product of claim 17, wherein the first instructions is initiated when a user input terminating a conversation is received.

23. A data processing system comprising:
a bus system;
a memory connected to the bus system, wherein the memory includes a set of instructions; and
a processing unit connected to the bus system, wherein a processing unit executes a set of instructions to identify a number of current conversations open for a user in the messaging program; and set a user status to busy if the number of current conversations for the user equals a threshold.
